(19) United States
(12) Patent Application Publication
(10) Pub. No.: US 2018/0254643 A1
(43) Pub. Date: Sep. 6, 2018

(54) ELECTRIC VEHICLE HIGH POWER MULTI-PORT PRIORITY-BASED CHARGER

(71) Applicant: Princeton Satellite Systems, Inc., Plainsboro, NJ (US)

(72) Inventors: Michael Paluszek, Princeton, NJ (US); Marilyn Ham, Princeton, NJ (US); Gary Pajer, Yardley, PA (US); Stephanie Thomas, West Windsor, NJ (US)

(73) Assignee: Princeton Satellite Systems, Inc., Plainsboro, NJ (US)

(21) Appl. No.: 15/910,755

(22) Filed: Mar. 2, 2018

Related U.S. Application Data
(60) Provisional application No. 62/466,202, filed on Mar. 2, 2017.

(51) Int. Cl. H02J 7/00; H02J 1/10; B60L 11/18

(52) U.S. Cl. CPC H02J 7/0027; H02J 1/102; B60L 11/1816; H02J 2001/106; B60L 11/1861; B60L 11/184; H02J 2007/0095; B60L 11/1812

(57) ABSTRACT

A system for recharging electric vehicles that optimizes the distribution of power to the users. The system meets the requirements of all the users for charging within their available time window while minimizing the cost of charging for the charging station.

### CROSS REFERENCE TO RELATED APPLICATIONS

This application claims priority to U.S. Provisional Application Ser. No. 62/466,202, filed Mar. 2, 2017, the disclosure of which is incorporated herein by reference in its entirety.

### FIELD OF THE INVENTION

The present disclosure relates to high power charging of electric vehicles.

### BACKGROUND

Batteries in electric vehicles need to be recharged. High power electric vehicle battery charging, using Direct Current (DC) power ranging from 50 to 400 kW or more, allows electric vehicles to be charged rapidly. Typically, a high power DC charger can recharge electric vehicle batteries to up to 80% of their capacity in approximately 30 minutes.

A given charging station will have a limited amount of available power for charging and such available power must be distributed among all vehicles that are connected to the station. Limitations to the amount of available power may be due to grid power and/or the available rate of power delivery from to the local power utility company.

Cars may arrive and depart at any time. Users may want their cars to be charged immediately, for example if the driver is on a cross-county trip, or may be willing to wait for several hours. Another aspect is that charged rates, that is the cost per kW of charge power, may vary with time of day or with the power demanded by the charging station.

Numerous patents and applications for electric vehicle charging can be found.

U.S. Pat. No. 8,378,623B2 discloses an electric vehicle charging system but is for on-board charging.

U.S. Pat. No. 5,202,6171A discloses an electric vehicle charging station but does not deal with the problem of multiple cars. It discloses a method of determining the state of charge which is not needed in a practical system.

US20140117946A1 discloses a charging station that provides priority charging for severely depleted batteries. This disclosure again does not deal with problems associated with multiple cars at the same charging station.

US201301179061A1 employs an expert system to accommodate user preferences. This is inferior to the method disclosed in this invention. An expert system cannot provide an optimal, that is minimum energy, solution. It does accommodate user preferences. It does not disclose how those preferences are met nor how it knows that the car it is charging is the correct car. As such, it is not useful for real implementation.

U.S. Pat. No. 8,643,330 B2 discloses a rule based charging system. This disclosure does not anticipate the advantages of off-vehicle energy storage. This rule-based system is not optimal and is inflexible. This disclosure does not have an algorithm for optimizing rules and does not provide any means to detect which cars are using the charging points making his rule-based system unusable.

U.S. Pat. No. 8,504,227 B2, simply charges each car to capacity. This disclosure also does not use off-vehicle energy storage.

US 2013/0204471 A1 optimizes the charging of vehicles along their paths. It uses constrained optimization and user preferences. It is not for a single charging station. It is specifically for a charge exchange market.

### SUMMARY

A method for optimizing the distribution of power to electric vehicles to meet the car owners' charging requirements regardless of when the electric vehicles connect to the charging station.

A method that minimizes the cost of delivering the power to the electric vehicles.

A method that ensures that the correct car is being charged.

### BRIEF DESCRIPTION OF THE DRAWINGS

FIG. 1 is a diagram of an implementation of a car charging system.

FIG. 2 is a flow chart describing an implementation of a car charging process.

FIG. 3 is a flow chart describing an implementation of a charge optimization process.

FIG. 4 is a diagram of an implementation of a car identification hardware.

FIG. 5 is a diagram of an implementation of a car identification process.

### DETAILED DESCRIPTION

This disclosure describes is for a multi-port on-demand high power DC charger for electric vehicles. Electric vehicles (102) may be plug in hybrids or pure electric vehicles. The charger has the following features. The charger system includes a battery energy storage system (104). This battery system (104) may use one or more batteries and may include lithium batteries or flow batteries. Connected to the battery system (104) is an inverter/rectifier (106) that converts direct current (DC) power to alternating current (AC) (inverter) and vice versa (rectifier). The inverter/rectifier may be a three phase device that connects to a power grid (110) through a three phase power connection (108). A single unit will use a three phase AC to DC inverter/rectifier (108) and battery storage (104). Single phase AC lines may not deliver sufficient power.

A user would select a departure time (124) using dial (120), the number of miles the user wants to add using dial (122) or the percentage of charge desired using button (130) and the value using dial (126). These could be physical dials or virtual controls on a touchscreen.

For example, in a typical 8 to 5 work day the total available power in the 9 hour period is 120 kWh from the battery and 450 kWh from the grid. This may feed 10 or more charging ports (e.g. 132). When a person parks their car (102) they would connect to a port (132). The driver may optionally be able to select a departure time (124) and desired state of charge (130). The station may also identify the car and convert miles to percentage charge based on the make and model. This identification may be done via data passed through the charging point or by visual identification using the car presence sensor (112). The charger may charge cars attached to the ports so that each car was fully charged at the desired departure time. It could charge cars sequentially or in parallel ass appropriate. The amount of power delivered would depend on the departure time the driver entered. If they didn't enter a time they would be put into the charging queue at position determined by the priority of other cars that have already connected. Priority would change as cars are attached and detached. In an implementation designed to promote fairness, if a driver detaches a car to attach his/her car, the new car will not be charged unless the car that was detached was fully charged. The station may, for example, use the car presence sensor to determine arrivals and departures. The station may tell people their state-of-charge wirelessly.

It then supplies each with the power needed to fully charge the car by the departure time. The charger measures the amount of charge each car needs and the amount of time available. Assume 9 cars were connected at 8 am. 5 selected departure times of 5 pm and 3 had departure times of 12 pm. One did not specify a charge. The following gives an example of how the system operates. Those cars with departure times of 12 pm would have charging priority.

In the absence of paid-for priority charging, the charging system would attempt to meet the demands of all the drivers so that each driver got their expected charge. A user may pay for charge and may be able to pay a premium for faster charging. The battery may also be used in parallel with the grid connection. The charger may use the battery to prevent excessive draw from the grid. Power may be drawn first from the battery. The battery may, for example, be charged during off-peak hours.

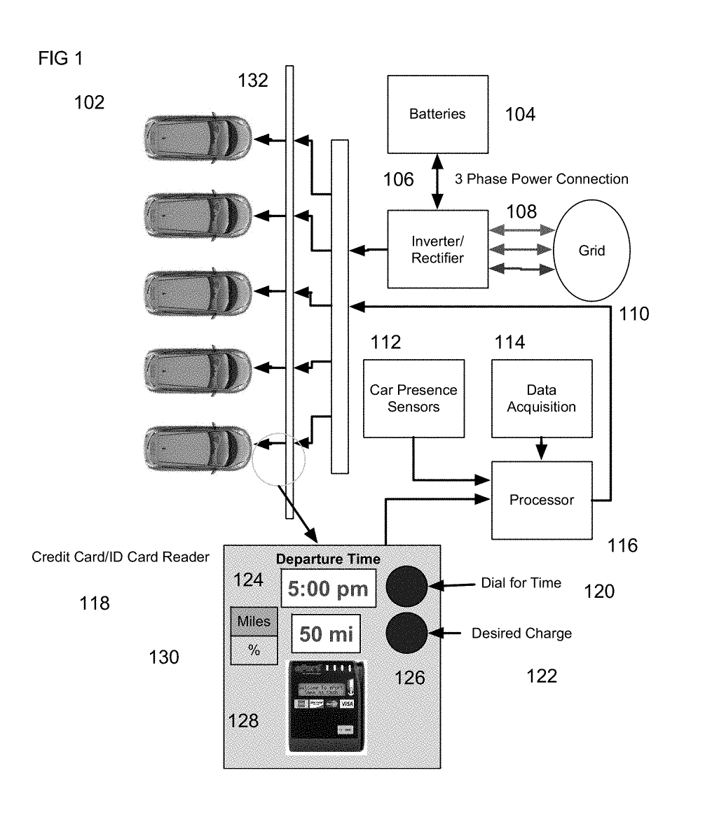

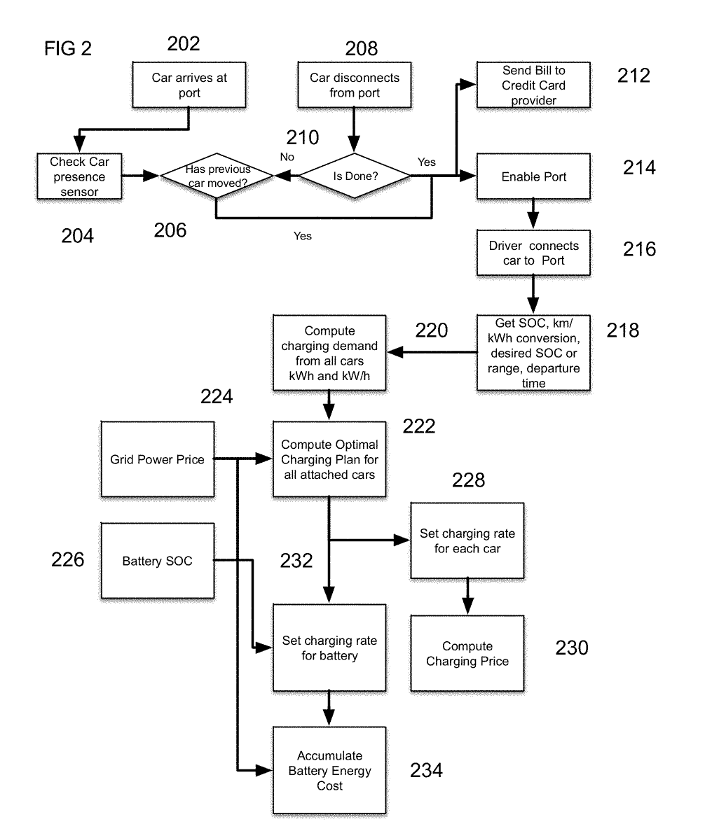

A car drives into a parking space (202) and is detected by the car sensor (204). The driver plugs his or her car into the charging station (216).Referring now to FIG. 2 a flowchart is shown of the operation of an implementation of a charging station. The station determines if the previous car has moved from its space (206). It checks to see if the previous car is disconnected (208) and if that user was finished (210). If yes it enables the port (214). If not, it will not charge the new car. This inhibits users from disconnecting other users whose cars are not yet fully charged. A mechanical interlock (not shown in FIG. 1) may also be employed to prevent disconnection prior to full charge. The driver then connects the car to the port (216).

The charging system controller receives information (218) regarding state-of-charge (SOC), distance/kWh conversion, desired ending SOC or range, and/or departure time. This information may be received or calculated automatically, may be entered manually by the driver, or a combination of the two. The driver, for example, may optionally enter (130) in a desired state of charge (SOC) and departure time (124). The default settings may be 100% SOC and 1 hour charge duration. These defaults may be changed by the station operator.

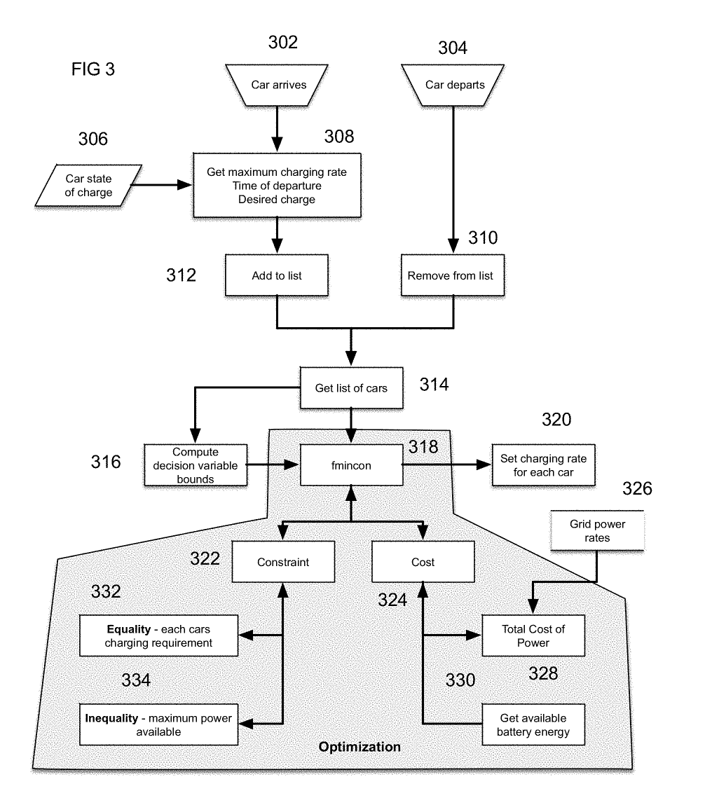

The grid power price is read in (224). The list, with the above data, may be passed to a optimization function that computes the optimal charging plan for all cars connected to the charging station (222). For example, the data The car is added to the list of cars to be charged (220). The charging demand for all connected cars may be updated. may be passed to the nonlinear programming algorithm fmincon (MATLAB software) or similar optimization function. This is shown in more detail in FIG. 3.

The function, fmincon solves problems of the form:

Minimize f(x) subject to the constraints

Ax<=B, A_{eq}x =B_{eq} x (Linear constraints)

C(x)<=0, C_{eq} (x)=0 (Nonlinear constraints) and x is between L_{B} and U_{B}, lower and upper bounds.

The battery energy cost is accumulated (234). This is done by determining the price of power when a kWh was passed into the battery. Thus the value of the energy is determined. The car charging price is computed (230). The battery SOC is read (228) and its charging rate is set (232).The charging rate for each car is set (228). Losses are factored into the battery energy cost (234).

The car is added to the charging list (312). The car state of charge is read in from the car battery (306).The maximum charging rate, time of departure and desired charge are read into the algorithm (308).A car arrives (302). Referring now to FIG. 3 a flow chart describing a optimization function is shown. When the car departs (304), which may be before it is done, it is removed from the list (310).

Prior to optimization, the list of cars is retrieved (314) and decision variable bounds, (x) discussed above, are computed (316). The optimization divides time up into time intervals from a current time until the last car is scheduled to depart. The time intervals may be of any length. The shorter the interval the more computation is required but the better the algorithm can optimize the charging. The function fmincon is a constrained optimization function and operates on the list of all cars (314). Constrained optimization is used in many technical areas but is non-obvious for car charging. A unique feature of this invention is that it categorizes the global charging problem as a constrained optimization problem.

If time is a control then the constraint is the maximum time available. If power is a control, a constraint is the maximum power available. Constrained optimization means that it optimizes some measure which is a function of the controls given constraints on the controls. Zero power and zero time are always constraints.

An inequality constraint (334): The charging rate must be less than maximum rate of the station at any given time. There will be one such constraint for every time interval. The constraints (322) fmincon (318) uses are as follows. 1) Available battery energy is obtained (330). Battery energy is used when insufficient grid power is available or when the battery energy is cheaper than the grid energy. The cost fmincon uses is based on the grid power rates (326). These may vary during the day so the total cost of power (328) will factor in the variation. The cost that it tries to minimize is the total dollar cost of charging the cars. The cost of power may be a function of time of day. A battery may be included and that is always charged when prices of electricity are lowest. Battery power is used preferentially over grid power. Battery charging can occur at other times if the power company wants battery power to be used to minimize grid transients. 2) An equality constraint (332): All cars must be charged to their desired SOC at their departure times.

A linear power amplifier can throttle the power going the car as an alternative. This may be done by pulse width modulating the power going to each car. Other methods are also possible. The output is used to set the charging rates for each car (320). The algorithm computes the charging rates for each car from a current time until departure time (134).An on/off system with fixed pulse widths can also modulate the power. These alternatives, however, are not as flexible as pulse width modulation.

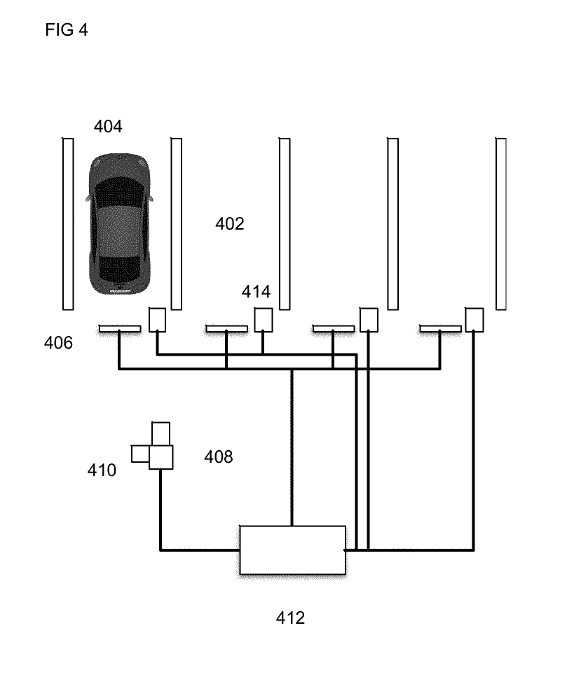

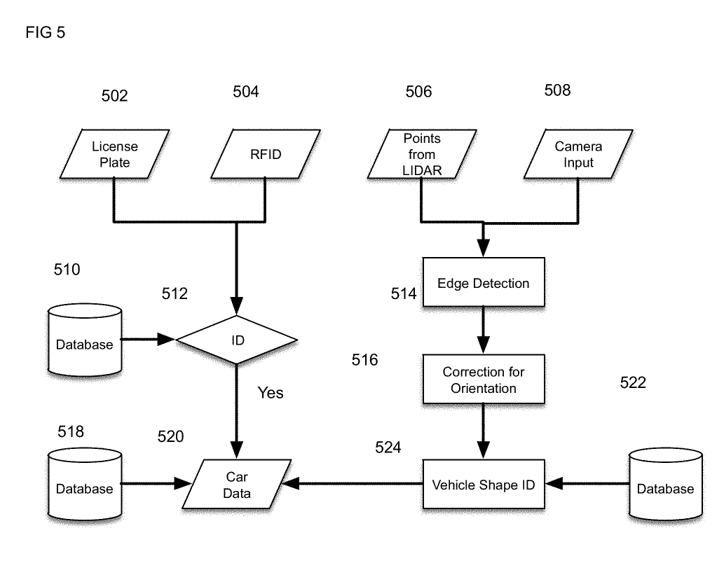

An important element of the system is that it can identify unambiguously the car that is in a charging spot. Referring to FIGS. 4 and 5 a diagram and flow chart describing how a car type is identified is shown. A car (404) parks in a space (402). A license plate scanner (406) and Radio-Frequency Identification (RFID) reader (414) are used to identify the car. If no identification is made a laser scanner (410) scans the car and identifies its edges. A camera (408) takes a picture of the car. If no identification is made a laser scanner (410) scans the car and identifies its edges. All data is passed to a processor (412).

FIG. 5 shows an example of an identification algorithm. In one example, the license plate is scanned (502) or an RFID tag attached to the EV is read (504). If a license plate number or RFID tag is found it is checked against a database (510) of vehicle identification numbers. If the EV is found car data is determined (520) from the database (518). Alternatively, LIDAR (506) or camera (508) is used to find the edges of the car. The orientation or the camera is used to transform the measurements into a convenient coordinate system (516). The found edges are then compared with a database (522) and the shape identified. (524). This is used to generate the car data (520). Car data (520) may include the energy depletion rate of the batteries, the range of the EV, the recommended SOC, and the like. Other examples are the maximum rate of charge, battery temperature, battery charge capacity and battery health.

Although the scenarios herein have been described with reference to particular embodiments, it is to be understood that these embodiments are merely illustrative of the principles and applications of the disclosed scenarios. It is therefore to be understood that numerous modifications may be made to the illustrative embodiments and that other arrangements may be devised without departing from the spirit and scope of the disclosed scenarios as defined by the appended claims.

1. A high power direct current (DC) electronic vehicle (EV) charger comprising:
a plurality of charging ports that are capable of charging batteries of EVs either sequentially or in parallel;
a charge controller configured to distribute power among the plurality of charging ports based on an optimization calculation based on information associated with each vehicle attached to each port wherein the information comprises at least a desired charge level, a duration of charge, and a cost per kilowatt/hour of energy used to charge.

2. The high power DC EV charger of claim 1 further comprising a battery to store power from an electrical grid.

3. The high power DC EV charger of claim 2 wherein charging ports are configured to charge the batteries of EVs from the battery or the grid based on user demand, cost of power, and minimization of grid transients.

4. a desired state of charge in miles/km or percentage and a The high power DC EV charger of claim 1 wherein the charge controller determines a charging priority of one EV based on desired departure time at which time the battery is to have reached a desired state of charge.

5. The high power DC EV charger of claim 1 wherein the distribution of power is optimized to best achieve user demands while meeting the grid priorities in claim 2

6. The high power DC EV charger of claim 1 wherein the user is informed of the state of charge.

7. The high power DC EV charger of claim 1 wherein a charging port is disabled if it is disconnected from an EV that is not yet fully charged.

8. The high power DC EV charger of claim 1 that has a mechanical interlock to prevent disconnection of an EV unless said EV is fully charged.

9. The high power DC EV charger of claim 1 further comprising a presence sensor to determine if an EV is in a space.

10. The high power DC EV charger of claim 9, wherein the presence sensor is a camera.

11. The high power DC EV charger of claim 10, wherein image data from the camera is used to determine a license plate number of a license plate attached to the EV.

12. The high power DC EV charger of claim 11, further comprising a database that relates license plate numbers with additional data regarding operational energy consumption of the EV.

13. The high power DC EV charger of claim 12, wherein the distribution of power is based, in part, information in the database related to the additional data.

14. The high power DC EV charger of claim 10, wherein image data from the camera of an EV is analyzed using edge detection and corrected based on an orientation of the EV to determine a vehicle shape

15. The high power DC EV charger of claim 14 further comprising a database that relates vehicle shapes with a make and model of the EV and includes additional data regarding operational energy consumption, wherein the vehicle shape of the EV is matched with a vehicle shape ID in the database.

16. The high power DC EV charger of claim 15, wherein the distribution of power is based, in part, information in the database related to the additional data.

17. The high power DC EV charger of claim 9, wherein the presence sensor is an radio frequency identification (RFID) detector configured to identify an EV based on an RFID tag present on the EV.
